(19) United States
(12) Patent Application Publication
(10) Pub. No.: US 2010/0004852 A1
(43) Pub. Date: Jan. 7, 2010

(54) NAVIGATION APPARATUS, NAVIGATION METHOD AND NAVIGATION PROGRAM

(75) Inventor: Tomoyuki KAWAMURA, Anjo-shi (JP)

Correspondence Address: LOWE HAUPTMAN HAM & BERNER, LLP, 1700 DIAGONAL ROAD, SUITE 300, ALEXANDRIA, VA, 22314, US

(73) Assignee: AISIN AW CO., LTD., Anjo-shi (JP)

(21) Appl. No.: 12/463,013

(22) Filed: May 8, 2009

(30) Foreign Application Priority Data
Jul. 2, 2008 (JP) 2008-172945

(51) Int. Cl. G01C 21/36

(52) U.S. Cl. 701/200

(57) ABSTRACT

A navigation device searches for a facility that matches a category input by a user and displays an icon for indicating the searched facility. The navigation device includes a usage determination unit and a display control unit. The usage determination unit determines whether a host vehicle has used the searched facility based on map information and a host vehicle status. If it is determined by the usage determination unit that the host vehicle has used the searched facility, the display control unit executes a control to change a display status of an icon for indicating the facility that was determined as used, and a display status of an icon for indicating another facility in the same category as the facility that was determined as used.

### INCORPORATION BY REFERENCE

The disclosure of Japanese Patent Application No. 2008-172945 filed on Jul. 2, 2008 including the specification, drawings and abstract is incorporated herein by reference in its entirety.

### BACKGROUND OF THE INVENTION

The present invention relates to a navigation device, a navigation method, and a navigation program. More specifically, the present invention relates to a navigation device, a navigation method, and a navigation program which display icons to provide guidance for various facilities.

### DESCRIPTION OF THE RELATED ART

Conventionally, a navigation device is used to perform route guidance to a destination. With such a navigation device, in addition to displaying roads, icons that indicate facilities matching categories input by the user are shown on a display screen. If an excessive number of icons are shown on the display screen, however, information for displaying roads and other necessary information may be hidden behind the icons and icons may be displayed overlapping with one another, which adversely affects the visibility and operability of the display screen.

As a countermeasure, a method has been proposed wherein if the number of facilities within a display area of a map is less than a predetermined value, the facilities are displayed as icons on the map; however, if the number of facilities is equal to or greater than the predetermined value, a representative icon display area is provided at a predetermined position in the display screen, and representative icons that indicate the category of acquired facilities are displayed in the representative icon display area (see Japanese Patent Application Publication No. JP-A-2006-275662, paragraph 0009).

### SUMMARY OF THE INVENTION

For the display of icons that indicate facilities that match the category input by the user, application of the method described in Japanese Patent Application Publication No. JP-A-2006-275662 simply displays representative icons that indicate categories of facilities in the representative icon display area provided in the display screen if the number of facilities present in the display area of the map is equal to or greater than the predetermined value. Thus, even after a facility is used, the representative icon may remain displayed and pose an obstacle to better visibility and operability.

The present invention was devised in order to solve the problems described above. The present invention provides a navigation device, a navigation method, and a navigation program that control changes in the display status of icons depending on whether a facility indicated thereby has been used, and improves the visibility and operability of a display screen.

According to a navigation device of a first aspect, a navigation method of a fifth aspect, and a navigation program of a sixth aspect of the present invention, if a usage determination unit determines that the host vehicle has used a searched facility, a control is executed to change the display status of the icon for indicating the facility that was determined as used and the display status of the icons for indicating other facilities in the same category as the facility that was determined as used. Therefore, icons for facilities no longer needed by the user can be changed to improve the visibility and operability of a display screen of a monitor.

According to the navigation device of a second aspect of the present invention, when the user inputs an instruction regarding changing the display status, the display control unit receives the instruction and changes the display status of an icon. Therefore, changes in the display status can reflect the user's intent and unnecessary icons can be changed.

According to the navigation device of a third aspect of the present invention, the display control unit executes a control to change the display status of the icon for indicating the facility that was determined as used and the display status of the icons for indicating other facilities in the same category as the facility that was determined as used, and which exist along the guidance route within a range reachable by the host vehicle during the time specified in the re-use time information. Because it is possible to change the display of icons that exist within a suitable range among icons shown along the guidance route, the visibility and operability of the display screen of the monitor can be improved.

According to the navigation device of a fourth aspect of the present invention, the display control unit deletes the icon for indicating the facility that was determined as used and the icons for indicating other facilities in the same category as the facility that was determined as used. Accordingly, the icons for facilities no longer needed by the user are omitted from the display screen of the monitor, which improves the visibility and operability of the display screen of the monitor.

### BRIEF DESCRIPTION OF THE DRAWINGS

FIG. 1 is a block diagram that shows a navigation device according to a first embodiment;

FIGS. 2A and 2B illustrate tables that show the contents of information stored in a usage condition database, where FIG. 2A is a table that shows usage condition information when a usage determination is made with changes in the state of a host vehicle at a facility used as a criterion, and FIG. 2B is a table that shows stay determination condition information for determining a length of stay when the length of stay at each facility is included in the criteria of FIG. 2A;

FIG. 3 is a flowchart that shows the flow of a display control process executed by the navigation device;

FIGS. 4A, 4B, and 4C are figures that show examples of a monitor displaying map information that includes facility icons;

FIGS. 5A and 5B are figures that show examples of a monitor displaying map information that includes facility icons;

FIGS. 6A and 6B are figures that show examples of a monitor displaying map information that includes facility icons;

FIG. 7 is a block diagram that shows a navigation device according to a second embodiment;

FIG. 8 is a table that shows the contents of information that is stored in a re-use information database; and

FIG. 9 is a flowchart that shows the flow of a display control process.

### DETAILED DESCRIPTION OF THE EMBODIMENTS

Hereinafter, embodiments of a navigation device, a navigation method, and a navigation program according to the present invention will be described in detail with reference to the drawings. However, the scope of the present invention is not limited to such embodiments.

### First Embodiment

A first embodiment of the present invention will be explained here. According to this embodiment, when it is determined that a facility that matches a category input by the user has been used by a host vehicle, a control is executed for changing the display status of an icon for indicating the facility determined as used by the host vehicle and the display status of an icon for indicating other facilities of the same category as the facility determined as used by the host vehicle.

(Configuration)

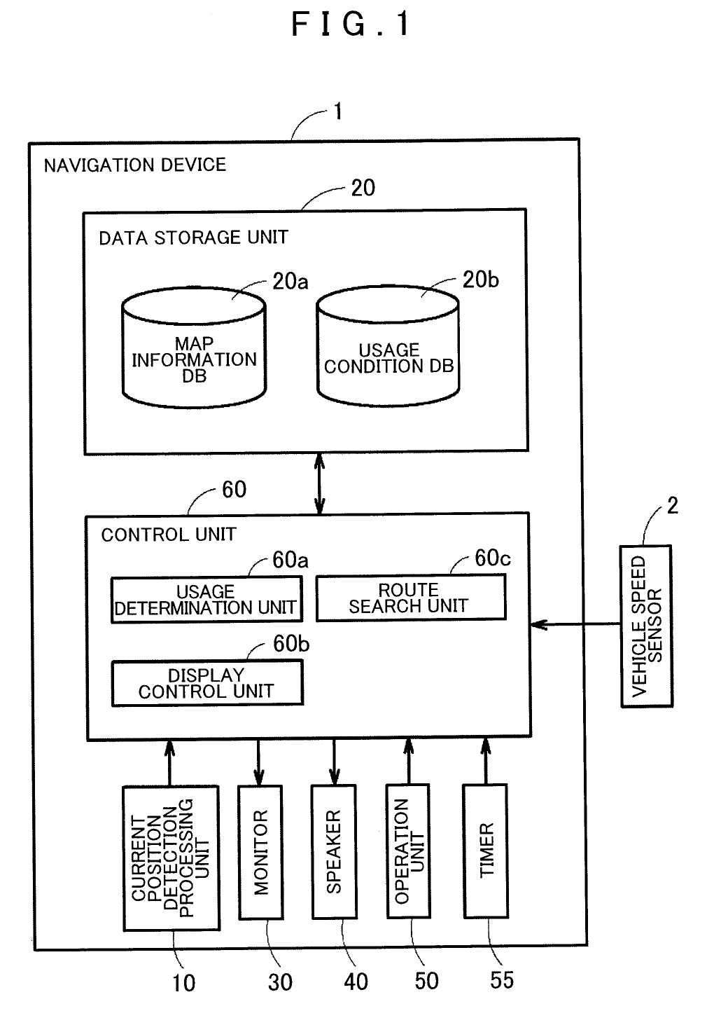

FIG. 1 is a block diagram that shows a navigation device according to a first embodiment. A navigation device 1 includes a current position detection processing unit 10, a data storage unit 20, a monitor 30, a speaker 40, an operation unit 50, a timer 55, and a control unit 60.

(Configuration: Current Position Detection Processing Unit)

The current position detection processing unit 10 detects the current position of a vehicle (referred to as a “host vehicle” below) installed with the navigation device 1. Specifically, the current position detection processing unit 10 has at least one of a GPS, a geomagnetic sensor, a distance sensor, a steering sensor, and a gyroscopic sensor (none of which are shown in the drawings), and detects the current position, heading, and the like of the host vehicle using a commonly known method.

(Configuration: Data Storage Unit)

The data storage unit 20 is a storage unit that stores programs and various data required for operation of the navigation device 1, and has a configuration that uses a hard disk (not shown) as an external memory device, for example. However, any other storage mediums, including a magnetic storage medium such as a magnetic disk or an optical storage medium such as a DVD or Blu-ray disc, can be used in place of or in combination with the hard disk.

The data storage unit 20 has a map information database 20a and a usage condition database 20b. (Note that database will be abbreviated to “DB” below.) The map information DB 20a is a map information storage unit that stores map information. The map information is information required for navigation, and is configured to include: facility data that is used for indicating facilities such as convenience stores, gas stations, restaurants, and parking lots (and which includes information that mutually associates the positions of each facility, the categories of facilities, and drawing information for icons that indicate the facilities); map display data for displaying a map on the monitor 30; and search data that is used for searching a route that leads to a destination (and which includes intersection data pertaining to intersection points, and node data pertaining to node points).

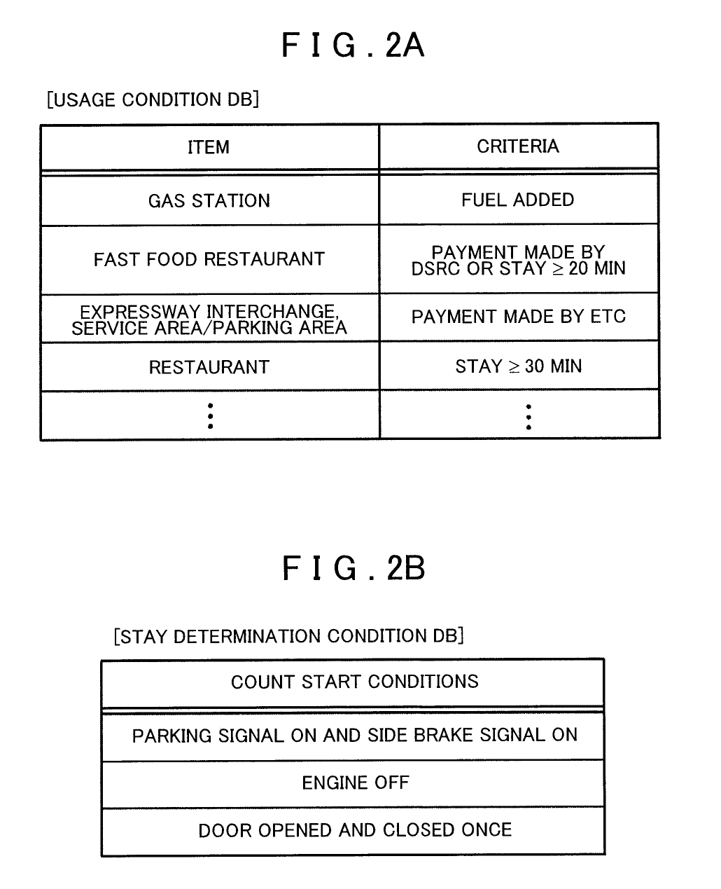

The usage condition DB 20b is a usage condition information storage unit that stores usage condition information. In this case, the usage condition information indicates criteria used when a usage determination unit 60a (described later) determines whether the host vehicle has used a particular facility. FIGS. 2A and 2B illustrate tables that show the contents of information stored in the usage condition DB 20b, where FIG. 2A is a table that shows usage condition information when a usage determination is made with the state of the host vehicle at a facility used as a criterion, and FIG. 2B is a table that shows stay determination condition information for determining a length of stay when the length of stay at each facility is included in the criteria of FIG. 2A.

In the example shown in FIG. 2A, information that corresponds to the headings of “item” and “criteria” is mutually associated and stored in the usage condition DB 20b. Information stored as corresponding to the item heading specifies the category of each facility that may be used by the host vehicle. In FIG. 2A, “gas station”, “fast food restaurant”, and the like are stored. Information stored as corresponding to the criteria item specifies the states used as criteria when usage is determined at each facility. In FIG. 2A, “fuel added”, “stay≧30 min”, and the like are stored.

In the example shown in FIG. 2B, information that corresponds to the count start conditions item and specifies conditions for starting to measure the length of time the host vehicle stays at a particular facility is stored (in FIG. 2B, “parking signal on and side brake signal on” and the like are stored) in the stay determination condition DB.

(Configuration: Monitor)

The monitor 30 displays map information that is output and controlled by a display control unit 60b (described later), and is also used for notification in order to prompt the user to input an instruction pertaining to controlling a change in the display status of an icon. The monitor 30 functions as a notification unit in the scope of the claims. A flat panel display such as a common liquid crystal display or organic EL display, a holographic device that projects a hologram on the windshield of the vehicle, and the like may be used as the monitor 30.

(Configuration: Speaker)

The speaker 40 is an output unit that outputs voice guidance pertaining to navigation, and a notification for prompting the user to input an instruction pertaining to controlling a change in the display status of an icon. The speaker 40 functions as the notification unit in the scope of the claims. Note that the specific voice output from the speaker 40 may take on any form, and it is possible to output a synthetic voice that is generated as necessary or a pre-recorded voice.

(Configuration: Operation Unit)

The operation unit 50 receives operational input from the user. Any content may be used as the specific operational input received through the operation unit 50. For example, setting a departure point and a destination, searching for a facility, and the like can be mentioned. The operation portion 50 may have any specific configuration, including a touch panel and push buttons on the front of the monitor 30, a remote operation unit such as a remote controller, or a voice recognition unit such as a microphone that receives voice input.

(Configuration: Timer)

The timer 55 is a time-measuring unit for measuring the length of time the host vehicle stays at a particular facility.

(Configuration: Control Unit)

The control unit 60 controls the navigation device 1. Specifically, the control unit 60 is a computer with a configuration that includes a CPU, various programs that are interpreted and executed in the CPU (including OS and other basic control programs, and application programs that are activated in the OS to carry out specific functions), and an internal memory such as a RAM for storing the programs and various data. In particular, the navigation program according to the present embodiment is installed in the navigation device 1 through any storage medium or network, and configures various portions of the control unit 60 in substance.

The control unit 60 includes the usage determination unit 60a, the display control unit 60b, and a route search unit 60c in terms of functional concept. The usage determination unit 60a determines whether the host vehicle has used a particular facility. The display control unit 60b controls the display of map information on the monitor 30, and controls changes in the display status of icons related to facilities. The route search unit 60c searches for a route from a departure point to a destination based on the map information. The processes that are executed by these functional elements of the control unit 60 will be described in detail later. Also note that a vehicle speed sensor 2 that detects the traveling speed of the host vehicle is connected to the control unit 60.

(Processing)

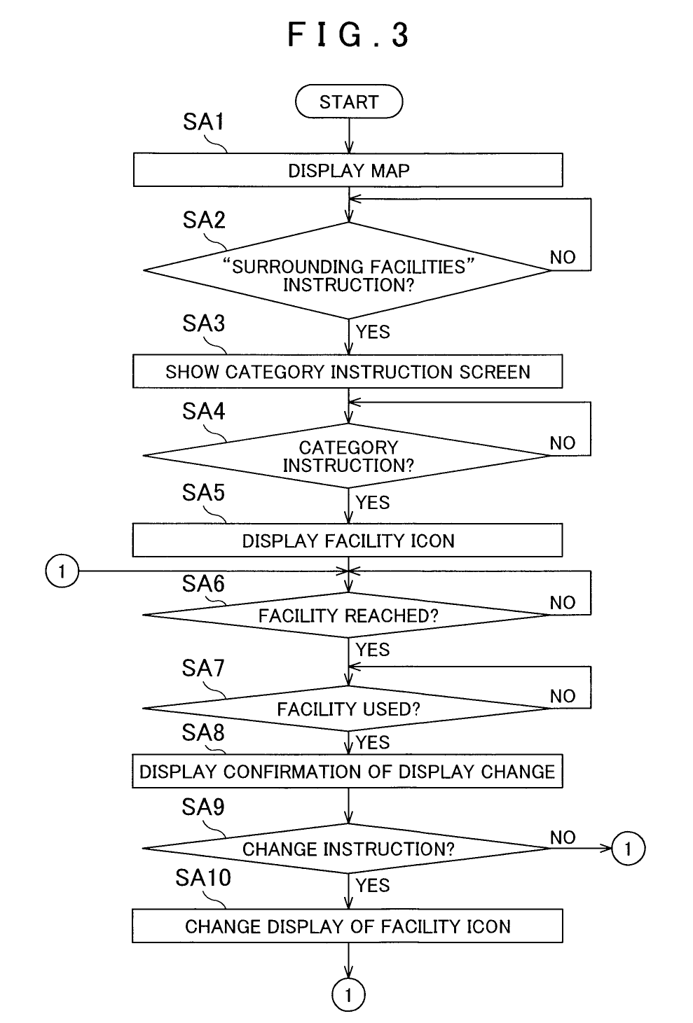

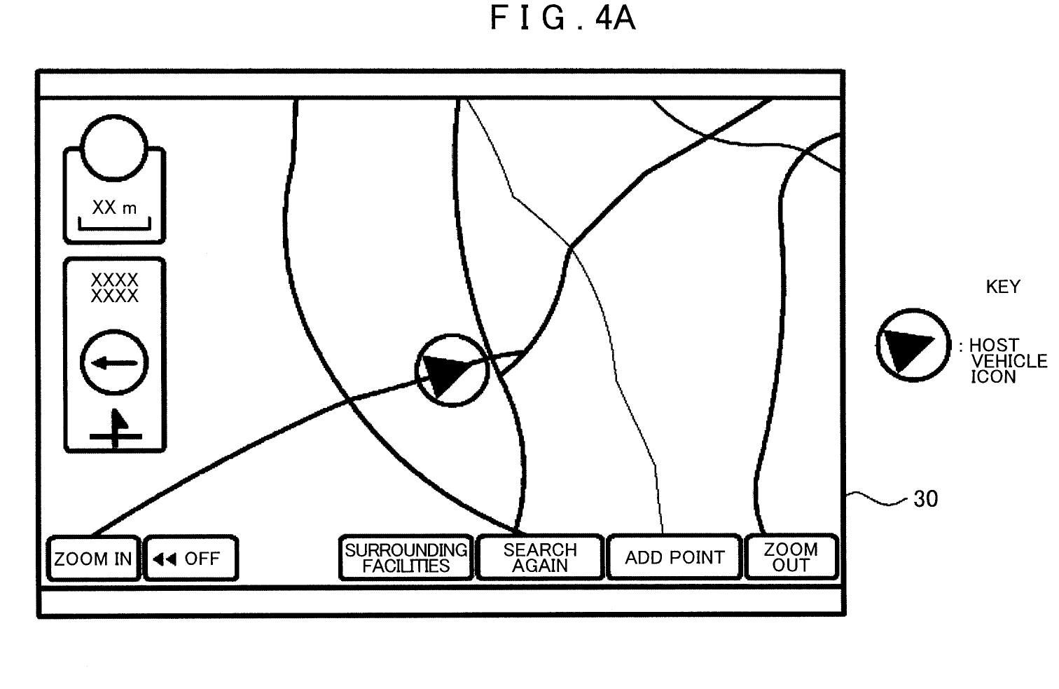

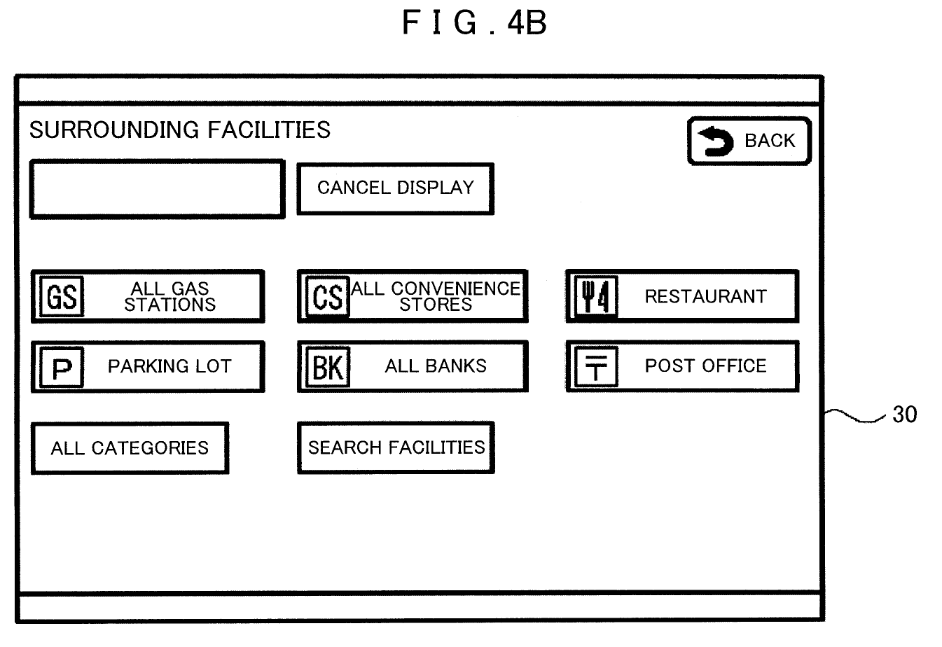

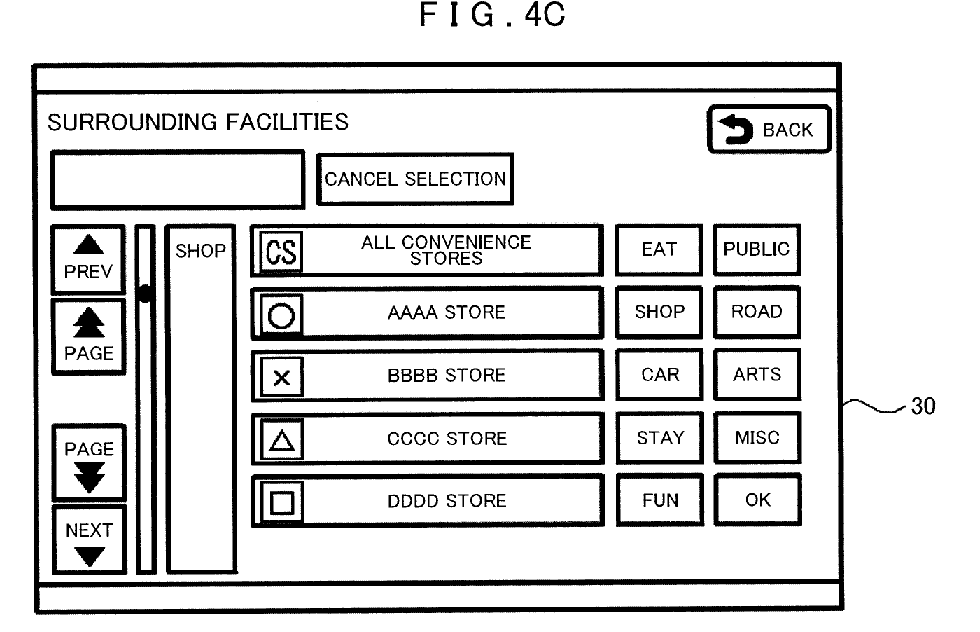

The display control process executed by the navigation device 1 with the above configuration will be explained below. FIG. 3 is a flowchart that shows the flow of the display control process executed by the navigation device 1. FIGS. 4 to 6 are drawings that show examples of the monitor 30 displaying map information that includes icons according to the display control process. (Note that step will be abbreviated to “S” in the following descriptions of each process.)

First, once the navigation device 1 is activated by an operation made through the operation unit 50 by the user at the start of vehicle travel or the like, the display control unit 60b refers to the map information DB 20a based on the current position of the host vehicle as acquired through the current position detection processing unit 10, and acquires map information for the surroundings of the current position, which it displays on the monitor 30 (SA1). FIG. 4A is a figure that shows an example of a state in which map information is output and displayed on the monitor 30 by the display control unit 60b. The monitor 30 displays map information such as roads and features of the surroundings of the host vehicle's current position. In addition, the monitor 30 displays in the vicinity of the center of the monitor 30 an icon that is a circle with a triangle inside that indicates the host vehicle, and displays buttons for touch panel operation in the vicinity of the bottom of the monitor 30.

Next, the display control unit 60b monitors whether the user has input an instruction to display surrounding facilities through the operation unit 50 (SA2). In the case of FIG. 4A, if it is determined that an instruction has been input to display surrounding facilities by pressing the “surrounding facilities” button displayed in the vicinity of the bottom of the monitor 30 (YES at SA2), the display control unit 60b displays a category instruction screen on the monitor 30 that enables the user to instruct the category of facilities to be displayed (SA3).

FIG. 4B is a figure that shows an example of a state in which the category instruction screen is displayed on the monitor 30 by the display control unit 60b. The monitor 30 shows buttons such as “all gas stations”, “all convenience stores” and the like as the categories of facilities. If any of these buttons are pressed, the display control unit 60b judges that the category corresponding to the pressed button has been selected by the user.

The facility categories are further classified into a plurality of layers, such that if a category in one layer is selected, the user can further select a category in a subordinate layer. FIG. 4C is a figure that shows a category instruction screen displayed on the monitor 30 when the “all convenience stores” button is selected in the screen exemplified in FIG. 4B. As illustrated in FIG. 4C, when the “all convenience stores” button is selected in FIG. 4B, buttons that correspond to categories classified by franchise chain, such as AAAA store and BBBB store, are displayed as categories of facilities included in the convenience store category, and these categories can be selected by the user.

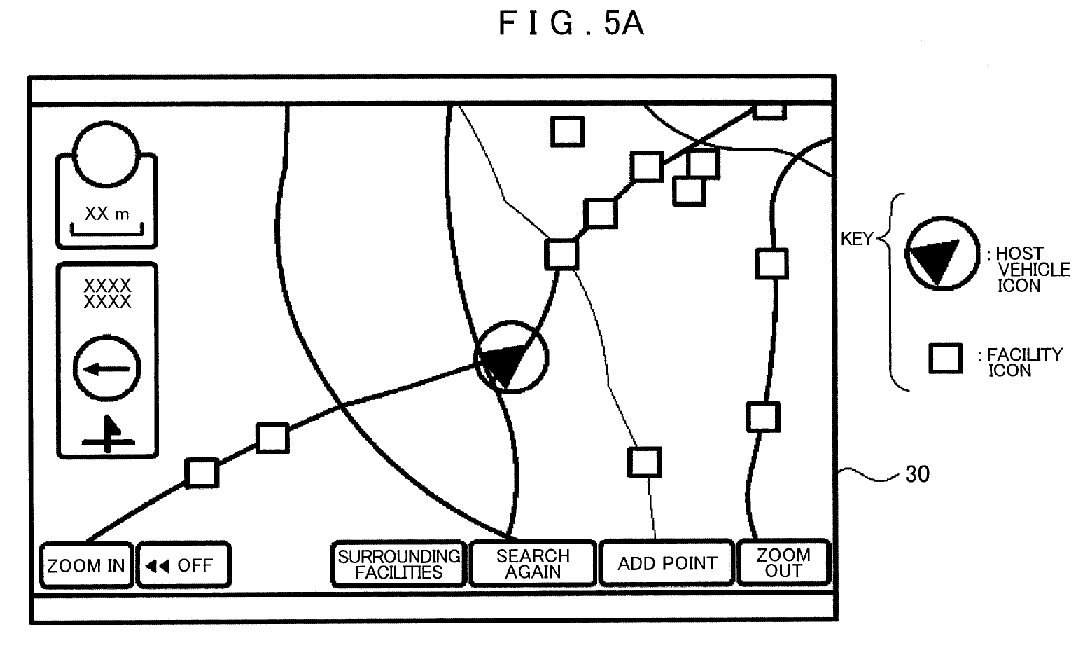

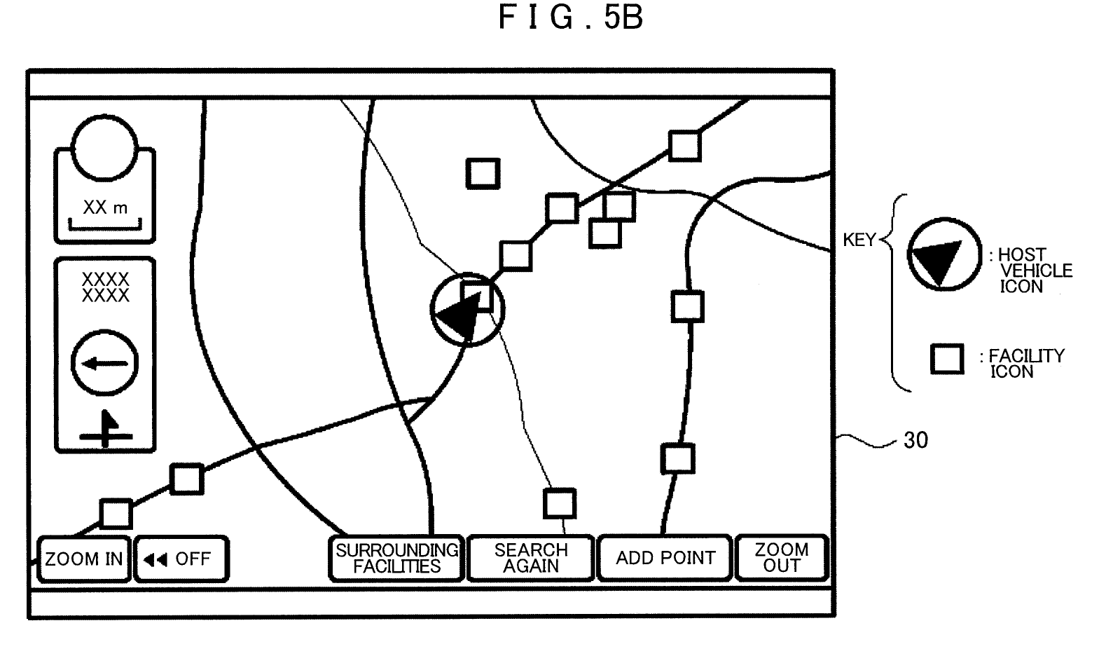

If it is determined that the user has input an instruction on the facility category in the category instruction screen (YES at SA4), the display control unit 60b extracts facility data that includes the category of facilities that matches the category instructionally input from among the facility data of the map information DB 20a. Based on the positions of facilities that are included in the extracted facility data, the display control unit 60b specifies the positions of the facilities in the map information and draws using drawing information that is included in the extracted facility data at the specified positions so as to superimpose and display icons on the map information of the monitor 30 (SA5). FIG. 5 shows display screens of the monitor 30 with icons that are facility icons superimposed and displayed on the map information shown in FIG. 4A. In FIG. 5, the plurality of squares displayed indicates facility icons. Thus, the positions of facilities that match the category selected by the user are displayed on the map in a manner that is easily recognizable by the user.

Next, the display control unit 60b monitors whether the host vehicle has reached a facility (referred to as a “displayed facility” below) for which a facility icon is displayed on the monitor 30 (SA6) (the state shown in FIG. 5A). Regarding the determination of whether the host vehicle has reached the displayed facility, the host vehicle can be determined as having reached the displayed facility if the distance between the host vehicle and the displayed facility is equal to or less than a predetermined distance, for example.

If the host vehicle has reached the displayed facility (YES at SA6) (the state in FIG. 5B), the usage determination unit 60a determines whether the displayed facility has been used by the user (SA7). Specifically, the usage determination unit 60a refers to the usage condition DB 20b, and acquires criteria stored in association with the category (item) that corresponds to the displayed facility at which the host vehicle has arrived. Based on the status of the host vehicle employed as the criteria, the usage determination unit 60a determines whether the displayed facility has been used.

In the example shown in FIG. 2A, when the host vehicle arrives at a displayed facility classified in the gas station category, the host vehicle is determined as having used the displayed facility if a fuel increase is detected in the host vehicle. When the host vehicle arrives at a displayed facility classified in the fast food restaurant category, the host vehicle is determined as having used the displayed facility if a fee payment has been made through communication that uses DSRC (dedicated short range communication) or if the host vehicle stays at the displayed facility longer than a predetermined length of stay. Further, when the length of stay is included in the criteria of FIG. 2A, it is determined whether the length of stay has been exceeded based on the stay determination condition information in FIG. 2B. For example, as exemplified in FIG. 2A, because the criteria for a displayed facility in the restaurant category (item) is “stay≧30 min”, it is determined whether the length of stay has exceeded 30 minutes or more based on the condition information in FIG. 2B.

Specifically, whether the host vehicle meets all the conditions stored under the heading of “count start conditions” is monitored. If the conditions have been met, the timer 55 starts counting the host vehicle's length of stay at the facility. As exemplified in FIG. 2B, the timer 55 starts counting the length of stay at the facility when the parking signal and the side brake signal are both on, when the engine is stopped, and when a door is opened and closed once. If the engine of the host vehicle starts running after a preset length of stay has passed, it is determined that the displayed facility has been used. Note, however, that counting the length of stay at a facility by the timer 55 may also be started when any one of the conditions stored under the heading of count start conditions is met. Further note a displayed facility may be determined as used when the host vehicle has reached the displayed facility (YES at SA6).

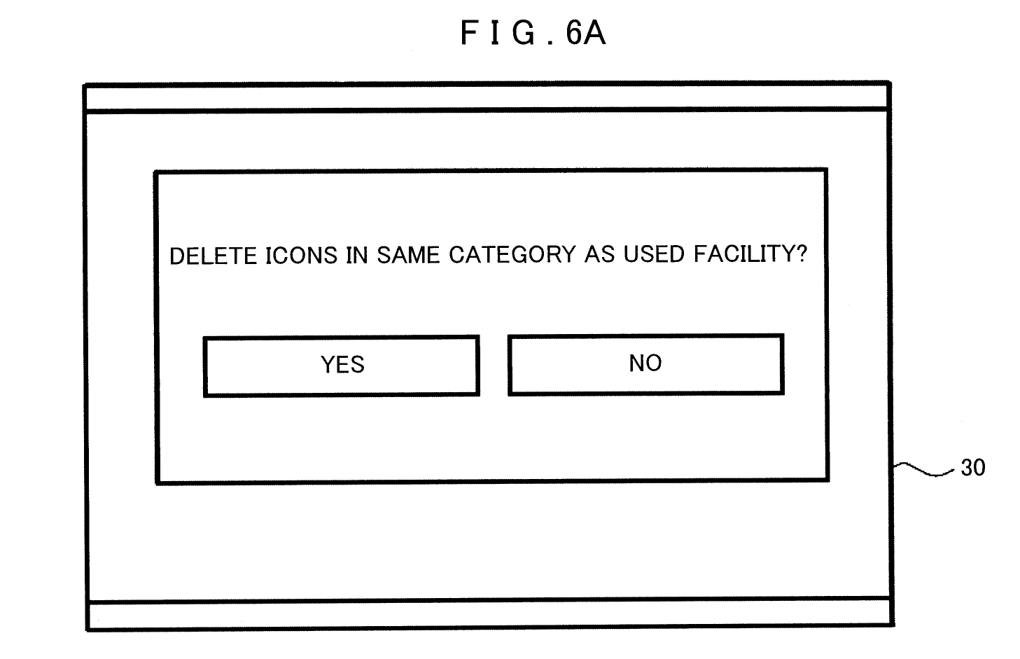

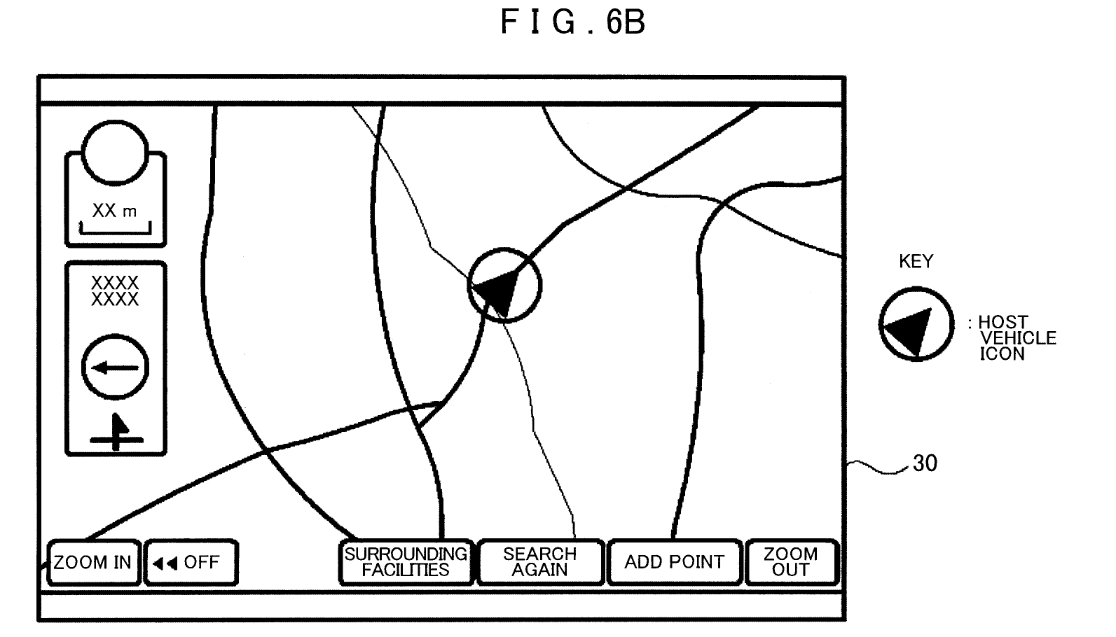

Based on the determination as described above, if it is determined that the displayed facility reached by the host vehicle has been used (YES at SA7), the display control unit 60b communicates to the user a prompt for instructional input regarding the contents of changes in the display status of the icon for indicating the facility that was determined as used, and the display status of icons for indicating other facilities of the same category as the facility that was determined as used (SA8). Any communication method may be used. For example, as FIG. 6A shows, a display for confirming whether to change the display of facility icons may be output to the monitor 30, or voice information output through the speaker 40 may be used to prompt instructional input from the user.

If the user inputs an instruction to change the display status of the facility icons through the operation unit 50 (YES at SA9), the display control unit 60b changes the display status of the facility icons (SA10). The contents of changes to the display of the facility icons may take on any specific form, such as deleting, minimizing, or making semi-transparent the facility icons related to displayed facilities that match the category which includes the displayed facility that was used, and which is the category instructionally input by the user at SA4. FIG. 6B shows an example in which the facility icons related to the displayed facilities that match the category are deleted. When changing the display status in this manner, in addition to the facility icon for indicating the displayed facility that was determined as used, the facility icons for indicating other facilities in the same category as the facility that was determined as used are also subject to the change. For example, the gas station category may be instructionally input by the user and a plurality of gas station facility icons displayed. In such case, if it is determined that the user has used any one of the gas stations among the plurality of gas stations, the display of the facility icon for the gas station used and the display of the facility icons for all gas stations besides that particular gas station are deleted, minimized, or made semi-transparent.

Alternatively, among the facility icons currently displayed, the facility icon for indicating the displayed facility that was determined as used and the facility icons for indicating other facilities in the same category as the facility that was determined as used may be removed. At the same time, a re-show button represented as a single button for instructing the display of the removed facility icons again may be displayed at a predetermined location in the monitor 30. If the user selects the re-show instructional button at any timing, the previously removed facility icons may be displayed again.

After the display status of the facility icons is changed at SA10 or if the user has not input an instruction to change the display status of the facility icons (NO at SA9), the display control unit 60b returns to the process at SA6 and again monitors whether the host vehicle has reached a displayed facility.

(Effects)

According to the first embodiment described above, if the usage determination unit 60a determines that the host vehicle has used a searched facility, a control is executed to change the display status of the icon for indicating the facility that was determined as used and the display status of the icons for indicating other facilities in the same category as the facility that was determined as used. Therefore, facility icons for facilities no longer needed by the user can be changed to improve the visibility and operability of the display screen of the monitor 30.

When the user inputs an instruction regarding changing the display status, the display control unit 60b executes a control to change the display status of an icon. Therefore, changes in the display status can reflect the user's intent and unnecessary icons can be changed.

If there is a plurality of facilities that matches the category input by the user, the display control unit 60b changes the display status such that only a single re-show instructional button is displayed that corresponds to the category. Therefore, facilities no longer needed by the user can be replaced with a single re-show instruction button in order to improve the visibility and operability of the display screen of the monitor 30.

The display control unit 60b deletes the icon for indicating the facility that was determined as used and the icons for indicating other facilities in the same category as the facility that was determined as used. Accordingly, the facility icons for facilities no longer needed by the user are omitted from the display screen of the monitor 30, which improves the visibility and operability of the display screen of the monitor 30.

### Second Embodiment

A second embodiment of the present invention will be explained here. In this embodiment, a control is executed for changing the display status of facility icons related to facilities that match the category input by the user and which exist along the guidance route of the host vehicle. The configurations of the second embodiment and subsequent embodiments are generally identical to the configuration of the first embodiment unless otherwise noted. For configurations generally identical to the configuration of the first embodiment, the same reference symbols and/or names as used in the first embodiment are assigned as necessary and accompanying explanations are omitted.

(Configuration: Navigation Device)

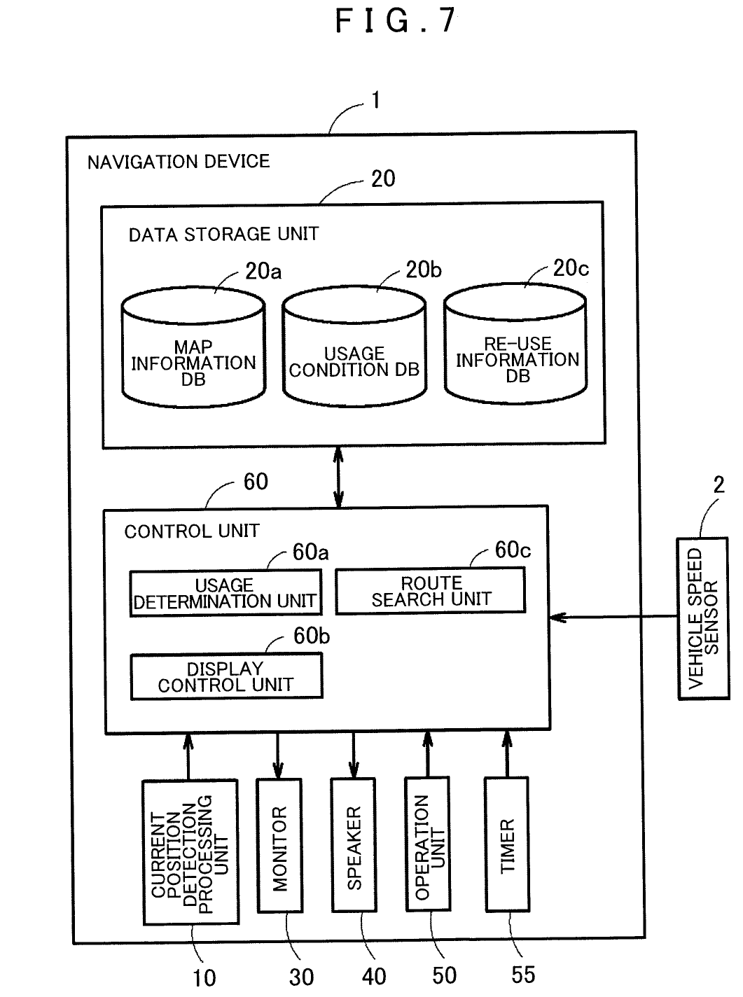

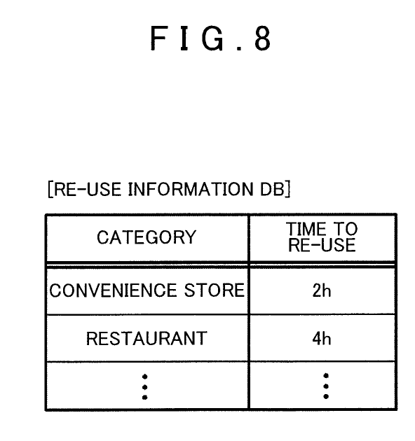

FIG. 7 is a block diagram that shows an electrical configuration of the navigation device according to the second embodiment. The data storage unit 20 of the navigation device 1 includes a re-use information DB 20c. The re-use information DB 20c is a re-use information storage unit for storing re-use time information that specifies the time until a used facility is used again. FIG. 8 is a table that shows the contents of information that is stored in the re-use information DB 20c. In the example shown in FIG. 8, information that corresponds to the headings of “category” and “time to re-use” is mutually associated and stored in the re-use condition DB 20c. Information stored as corresponding to the category heading specifies the categories of facilities. In FIG. 8, “convenience store”, “restaurant”, and the like are stored. Information stored as corresponding to the heading of time to re-use specifies the time to re-use regarding facilities in each category. In FIG. 8, “2 h” and “4 h” are stored for the categories of convenience store and restaurant, respectively. Note that the re-use information DB 20c may store re-use distance information that specifies the distance the host vehicle moves until a used facility is used again. For example, distance information such as the distance the host vehicle can travel on a full tank of gas, or the like may be stored in association with the gas station category (not shown).

(Processing)

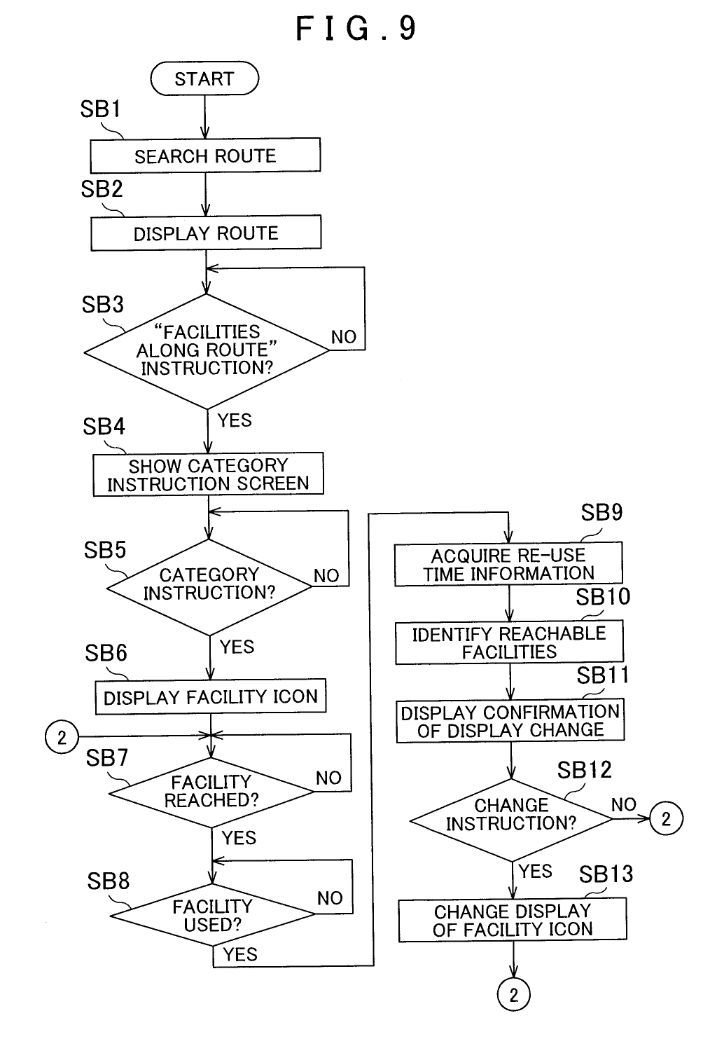

Next, the display control process executed by the navigation device 1 according to the second embodiment will be explained. FIG. 9 is a flowchart that shows the flow of the display control process.

First, following activation of the navigation device 1 by an operation made through the operation unit 50 by the user at the start of vehicle travel or the like, setting of a destination, and instructional input to start route guidance, the route search unit 60c searches for a route to the set destination (SB1). The searched route is then displayed on the monitor 30 superimposed on the map information (SB2). Note that explanations of the specific route search method and route display method are omitted here because commonly known techniques can be used.

Next, the display control unit 60b outputs a display to the monitor 30 that prompts the user to input an instruction regarding whether to display facility icons related to facilities that exist along the searched guidance route on the monitor 30, and monitors whether the user has input an instruction (SB3). If the user has input an instruction through the operation unit 50 (YES at SB3), the display control unit 60b displays on the monitor 30 a category instruction screen that enables the user to instruct the category of facilities to be displayed (SB4).

The process content at SB5 to SB8 is identical to the process content at SA4 to SA7 in the display control processing explained with reference to FIG. 3 in the first embodiment, and will be omitted here.

If it is determined at SB8 that the displayed facility reached by the host vehicle has been used (YES at SB8), the display control unit 60b acquires from the re-use information DB 20c the re-use time information stored in association with the category that includes the displayed facility that was used (referred to as a “used category” below), and which is the category instructed by input from the user at SB5 (SB9). In the example shown in FIG. 8, when “convenience store” is the used category, the re-use time information that specifies “2 h” as the corresponding time to re-use is acquired.

Next, based on the map information, the display control unit 60b identifies facilities that match the used category, and that exist along the guidance route within a range reachable by the host vehicle during the time specified in the acquired re-use time information (SB10). The distance reachable by the host vehicle can be specified by a commonly known method based on the current position, the average speed of the host vehicle, the map information, etc., and will therefore not be explained here.

Next, the display control unit 60b communicates to the user a prompt for instructional input regarding the contents of changes in the display status of the facility icons of facilities that match the used category specified at SB10 (SB11). If the user inputs an instruction to change the display status of the facility icons through the operation unit 50 (YES at SB12), the display control unit 60b changes the display status of the facility icons (SB13). Specifically, the display control unit 60b deletes, minimizes, or makes semi-transparent the display of the facility icon of the facility that was determined as used at SB8, as well as the display of facility icons of facilities that match the used category specified at SB10, and which are facility icons of facilities that are in the same category as the facility that was determined as used. Alternatively, the display control unit 60b changes the display status of the monitor 30 such that only a single re-show instructional button is displayed that corresponds to the category.

After the display status of the facility icons is changed at SB13 or if the user has not input an instruction to change the display status of the facility icons (NO at SB12), the display control unit 60b returns to the process at SB7 and again monitors whether the host vehicle has reached a displayed facility.

(Effects)

According to the second embodiment as described above, in addition to having effects that are identical to all or part of the first embodiment, a control is executed to change the display status of the icon for indicating the facility that was determined as used and the display status of the icons for indicating other facilities in the same category as the facility that was determined as used, and which exist along the guidance route within a range reachable by the host vehicle during the time specified in the re-use time information. Because it is possible to change the display of icons shown along the guidance route within a suitable range by icon category, the visibility and operability of the display screen of the monitor 30 can be improved.

### Modifications of Embodiments

Embodiments of the present invention were explained above. However, the specific configuration and units for implementing the present invention may be modified and improved in any manner or form within the scope of the technical ideas of the present invention as set forth in the claims thereof. Examples of such modifications are explained below.

### Problems to be Solved by the Invention and Effects of the Invention

The problems to be solved by the present invention and the effects of the present invention are not limited to the content described above and may vary depending on the environment in which the present invention is practiced and the detailed configuration thereof. The above problems may be only partially solved, and the above effects only partially achieved.

### Reciprocity of the Embodiments

The embodiments explained above can be mutually combined in any combination. For example, the first embodiment and the second embodiment may be combined such that the display control unit 60b is configured so as to execute the display control processing with respect to the facility icons for facilities around the host vehicle when route guidance is not performed, and execute the display control processing with respect to the facility icons for facilities that exist along the guidance route when route guidance is performed.

(Display Control Unit)

In the above embodiments, the display control unit 60b was described as executing a control that changes the display status of facility icons related to facilities that match the category which includes the facility that was used, and which is the category instructionally input by the user. However, the display control unit 60b may also execute a control that changes the display status of facility icons related to facilities that match the category of a superordinate or subordinate layer of the category which includes the facility that was used. For example, if the category which includes the facility that was used is the name “AB Mart” of a specific convenience store chain is a category that belongs in a subordinate layer to the category of “convenience store”, a control may be executed that changes the display status of facility icons related to facilities that match the superordinate category of “convenience store”. Alternatively, if the category which includes the facility that was used is the category of “convenience store”, a control may be executed that selectively changes the display status of facility icons regarding facilities that match all categories subordinate to the category of “convenience store” and regarding facilities that match the single category of “AB Mart” selected by the user from among the subordinate categories. In such case, a display that prompts the user for instructional input regarding which display control content to use may be output to the monitor 30, and a control may be executed that changes the display status of the facility icons based on the instruction input by the user through the operation unit 50.

What is claimed is:

1. A navigation device that searches for a facility that matches a category input by a user and displays an icon for indicating the searched facility, the navigation device comprising:
a usage determination unit that determines whether a host vehicle has used the searched facility based on map information and a host vehicle status; and
a display control unit that, if it is determined by the usage determination unit that the host vehicle has used the searched facility, executes a control to change a display status of the icon for indicating the facility that was determined as used, and a display status of the icon for indicating another facility in the same category as the facility that was determined as used.

2. The navigation device according to claim 1, further comprising:
a notification unit that, if it is determined by the usage determination unit that the host vehicle has used the searched facility, prompts instructional input pertaining to a content of the control to change the display status of the icon for indicating the facility that was determined as used and the display status of the icon for indicating another facility in the same category as the facility that was determined as used, wherein
if instructional input is received through a predetermined input unit, the display control unit executes the control to change the display status of the icons based on the instructional input.

3. The navigation device according to claim 1, further comprising:
a re-use information storage unit that mutually associates and stores a category and re-use time information that specifies a time to re-use after a facility that matches the category has been used, wherein
the display control unit, if it is determined by the usage determination unit that the host vehicle has used the searched facility, acquires from the re-use information storage unit the re-use time information that stored in association with the category including the searched facility that was determined as used, and
executes the control to change the display status of the icon for indicating the facility that was determined as used and the display status of the icon for indicating another facility in the same category as the facility that was determined as used, said icon being an icon for indicating a facility that exists in a range reachable by the host vehicle during a time specified in the acquired re-use time information.

4. The navigation device according to claim 2, further comprising:
a re-use information storage unit that mutually associates and stores a category and re-use time information that specifies a time to re-use after a facility that matches the category has been used, wherein
the display control unit, if it is determined by the usage determination unit that the host vehicle has used the searched facility, acquires from the re-use information storage unit the re-use time information that stored in association with the category including the searched facility that was determined as used, and
executes the control to change the display status of the icon for indicating the facility that was determined as used and the display status of the icon for indicating another facility in the same category as the facility that was determined as used, said icon being an icon for indicating a facility that exists in a range reachable by the host vehicle during a time specified in the acquired re-use time information.

5. The navigation device according to claim 1, wherein
if it is determined by the usage determination unit that the host vehicle has used the searched facility, the display control unit deletes the display of the icon for indicating the facility determined as used by the host vehicle and the display of the icon for indicating another facility of the same category as the facility determined as used by the host vehicle.

6. The navigation device according to claim 2, wherein
if it is determined by the usage determination unit that the host vehicle has used the searched facility, the display control unit deletes the display of the icon for indicating the facility determined as used by the host vehicle and the display of the icon for indicating another facility of the same category as the facility determined as used by the host vehicle.

7. The navigation device according to claim 3, wherein
if it is determined by the usage determination unit that the host vehicle has used the searched facility, the display control unit deletes the display of the icon for indicating the facility determined as used by the host vehicle and the display of the icon for indicating another facility of the same category as the facility determined as used by the host vehicle.

8. The navigation device according to claim 4, wherein
if it is determined by the usage determination unit that the host vehicle has used the searched facility, the display control unit deletes the display of the icon for indicating the facility determined as used by the host vehicle and the display of the icon for indicating another facility of the same category as the facility determined as used by the host vehicle.

9. A navigation method that searches for a facility that matches a category input by a user and displays an icon for indicating the searched facility, the navigation method comprising the steps of:
determining whether a host vehicle has used the searched facility based on map information and a host vehicle status; and
if it is determined at the usage determination step that the host vehicle has used the searched facility, executing a control to change a display status of an icon for indicating the facility that was determined as used, and a display status of an icon for indicating another facility in the same category as the facility that was determined as used.

10. A navigation program that executes in a computer the navigation method according to claim 9.
